(19) United States
(12) Patent Application Publication
(10) Pub. No.: US 2006/0145824 A1
(43) Pub. Date: Jul. 6, 2006

(54) Method and device for detecting an object or a person

(76) Inventors: Henryk Frenzel, Regensburg (DE); Stephan Voltz, Happurg (DE)

Correspondence Address: LERNER GREENBERG STEMER LLP, P O BOX 2480, HOLLYWOOD, FL, 33022-2480, US

(21) Appl. No.: 10/518,350

(22) PCT Filed: May 6, 2004
(86) PCT No.: PCT/EP04/50720

§ 371 Date: Oct. 14, 2005

(30) Foreign Application Priority Data
May 8, 2003 (DE) 103-20-714.7

(51) Int. Cl. B60R 25/10

(52) U.S. Cl. 340/426.26

(57) ABSTRACT

The invention relates to a method and a device for detecting an object or a person (2), especially in a motor vehicle (1), using at least one illumination unit (3) which emits light pulses (4) for illuminating an image region (5) to be examined, and an image recording unit (6) comprising at least one image sensor (7) that receives light pulses reflected by an object (2) or a person in the image region and records the image information of the object (2). At least one illumination unit (3) is arranged in or on the motor vehicle (1) in such a way that it is spatially separated from the image detection unit (6). The invention is characterised in that one unit (6 or 3), out of the separated illumination unit (3) and the image recording unit (6), emits control light pulses (10) for the synchronisation or control of the units (3; 6) by means of a light wave emitter (8), and the other unit (3 or 6) receives the control light pulses (10) by means of a light wave receiver (9). In this way, both a thermally favourable location and a location which is favourable in terms of illuminating a scene of interest (5) inside and/or outside a motor vehicle (1) can be advantageously selected. The invention is not only especially suitable for passenger protection systems in modern motor vehicles (1), but for all motor vehicle-related video systems with active infrared illumination.

The present invention relates to a method and device for detecting an object or a person, especially in the passenger compartment of a motor vehicle.

The known devices for image data processing have an image capture unit with at least one image sensor which records an image line-by-line, for example, and immediately communicates the image data which has been captured line-by-line to an image control unit, via an image data bus. Such an image sensor is also referred to as a “Rolling Shutter” image sensor. The image control unit generally consists of an ASIC or an FPGA, which processes the image sensor data in real time, and via a 32-bit bus stores it temporarily in a buffer memory (e.g. DRAM). A microcontroller controls the ASIC and the data transmission in the image data processing system. In addition, the microcontroller analyses the image data held in the buffer memory. Finally the microcontroller, as part of an electronic control unit (ECU), for example for an occupant protection system, executes algorithms to analyze the image data which has been received.

For the case exemplified of line-by-line image recording from the image sensor, only a limited time period is available in the case of moving images for making the recording, because otherwise the recorded image will have been “smeared”. Consequently, all the data for the image must be transmitted within this limited time period, which results in a high data incidence rate.

Furthermore, the memory requirement for the image data is substantial. To solve this problem there is, for example, a device known from WO 02/41031 for image data processing which preferably has two image sensors, each of which has a so-called Sample & Hold device. An image sensor of this type can be switched to the active state, to capture an image, for a definable image capture time. After an image has been captured, the image data for the image which has been captured, consisting of individual pixels, can be temporarily stored for a definable storage time directly on the image sensor chip in a memory, e.g. a capacitor. The image is so-to-speak “frozen” into the image sensor. An image sensor with this type of design is preferably constructed using CMOS technology, and is also called a “Synchronized Shutter” image sensor.

The image data which is frozen in and stored on the image sensors is read out by a control device. The rate of read-out of the image data from the image sensors can then be adjusted to the processing speed of the microcontroller in the control device.

The provision of images or image sequences in or outside a motor vehicle is made more difficult by a series of restrictions or conditions, as applicable. In particular, one or more image capture units must work reliably under all lighting conditions. A known way of achieving this is to provide, in addition to the image capture device, an illumination unit which, for the purpose of illuminating the image field which is to be captured, emits for example very intense and short IR (=infrared) light pulses with wavelengths lying in the near infrared range (>800 nm) in order, for example, to avoid distracting or disturbing the driver and passenger. This takes place, in particular, while the image sensors are switched to the active state. The negative effect of the additional light arising from the ambient lighting, for example as a result of strong sunlight, can thus be reduced if the image capture time is the same as or of the same order of magnitude as the duration of the light pulse. To achieve good overall illumination, a large number of IR LEDs are currently required. If necessary, a diffuser or specially calculated optics are placed in front of the LEDs.

By using the shortest possible exposure times, in the range for example of 50 μs up to a maximum of 2 ms, it is also possible to capture a sharp image of moving objects. The maximum permissible speed of the objects in the image field which is to be captured at which it is still possible to capture a sharp image depends on the maximum duration of the light pulse and the time gap between successive light pulses. In this situation, it is preferable if each light pulse illuminates one image. The illumination is then not uninterrupted, but is synchronized with the recording by the image capture unit, and is preferably only provided when the external light from outside is insufficient. The LEDs thus only emit light pulses, also called IR flashes, when it is necessary and at the exact time when the image capture unit is recording an image. These LEDs can thus realize the IR pass at the same time.

Furthermore, the scene which is of interest must be well illuminated in spite of the limited installation space, and spatial arrangements which may be unfavorable, and the power loss or heat which results from the supplementary lighting must not damage the electronics of the complete system. However, if the illumination unit is accommodated in the same housing as the image capture unit with its image sensors and the analysis electronics, this results in the electronic components warming each other, so that only a relatively low operating temperature can be achieved for the system. In the case of the heating problem, attempts are made to overcome it by good quality and generally high-cost cooling measures, such as LEDs on aluminum boards (FR4 on Alu, Flex on Alu, or the like) and by good quality components with low power loss and a high operating temperature range.

Finally, an additional factor is that an illumination unit which has the same orientation as the image capture unit is not good for an image processing method which is primarily optimized for analyzing edge structures, because it casts hardly any shadows.

The object of the invention is to specify improved device as well as methods for capturing an object or a person, in particular in the passenger compartment of a motor vehicle, which significantly reduces the above-mentioned disadvantages.

This object is achieved by the characteristics of the independent claims. Advantageous embodiments and developments, which can be used individually or in combination with one another, are the subject of the dependent claims.

The invention for capturing an object or a person, for example inside the passenger compartment of a motor vehicle, with at least one illumination unit which emits light pulses for the purpose of illuminating an image field which is to be captured; and an image capture unit which incorporates at least one image sensor which takes in the light pulses reflected from an object or a person within the image field, and captures the image data for the object; in which at least one illumination unit is arranged to be spatially separated from the image capture unit within or on the motor vehicle; is characterized by the fact that of the separately-arranged illumination unit and image capture unit, the one unit an optical transmitter, which emits control light pulses for the purpose of synchronizing or controlling the unit, as applicable, and the other unit an optical receiver which receives the control light pulses. This enables an advantageous choice to be made of the location, so that it is both favorable from the heating point of view and also favorable for illuminating the scene which is of interest.

It is advantageous if a fiber optic cable is provided, arranged between the optical transmitter and optical receiver, for the purpose of transmitting the control light pulses.

Insofar as it is desirable to avoid a fixed cord, the laying of which can be extremely expensive, an alternative suggested for this purpose is the provision of transmission facilities on the optical transmitter and the optical receiver, for cordless transmission of the control light pulses.

It is preferred in accordance with the invention that the optical transmitter is a component of the image capture unit. The advantage of this is that the illumination does not need to be uninterrupted, but can be effected synchronously with the making of records by the image capture device, in particular in relation to the exact moment when the image capture unit is recording an image.

In order to achieve a high level of security against external sources of light pulses and against erroneous initiation of the illumination, it is advantageous if the control light pulse is transmitted in a form modulated by a signal or encoded by a suitable modulation method, as appropriate.

In accordance with the invention, control light pulses which have a wavelength lying in the near infrared range are preferred. The advantage of this is that it does not divert or disturb either the driver or the passenger or other occupants of the motor vehicle, or those in the traffic outside the motor vehicle.

For the purpose of improving the casting of shadows, the illumination unit is, in accordance with the invention, preferably directed towards the person or object of interest, as applicable, and is arranged relative to the image capture unit at an angle α which, for the purpose of avoiding excessively large dark areas, for example on the face of an occupant, will preferably be from 0° to 45° or (in the possible situation where several illumination units are used, also) between 135° and 180°, whereby the latter range of angles can be used to exploit counter-lighting effects to advantage. Both arrangement variants, which could of course also be used in combination, bring the particular advantage of improved illumination. It is preferable if the power supply for the illumination unit(s) is independent of that for the image capture unit, so that the power loss is also moved completely away from the image capture unit, which is an advantageous way of minimizing the heating problems mentioned in the introduction.

Finally, it is suggested that any possible timing offset between the time of illumination and the time of image recording is compensated by the control light pulses being emitted at an earlier point in time.

With the present invention it is easier to deal in an advantageous way with conditions of limited space, such as are typical for motor vehicle applications. In addition, the present invention permits better edge detection from the shadows which the illumination unit casts on structures and objects in the interior and/or the exterior of a motor vehicle. Finally, it permits easier adaptation to various “carlines” or vehicle types. The present invention is thus suitable not only for occupant protection systems in modern motor vehicles, but also for all motor vehicle related video systems using active IR illumination.

Additional details and further advantages of the invention are described below by reference to preferred forms of embodiment, in conjunction with the attached drawing.

This shows, in schematic form:

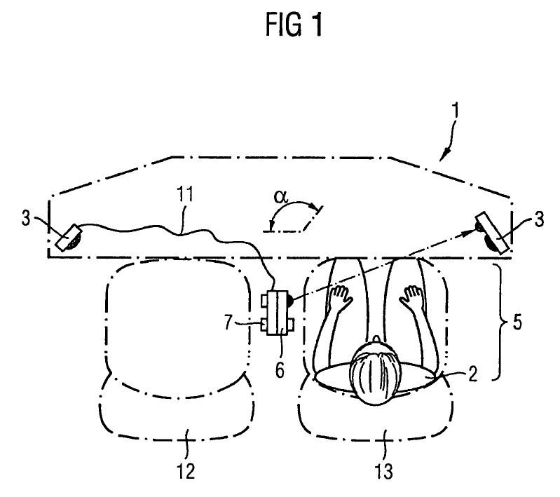

FIG. 1 device in accordance with the invention for capturing an object or a person in the interior space of a motor vehicle; and

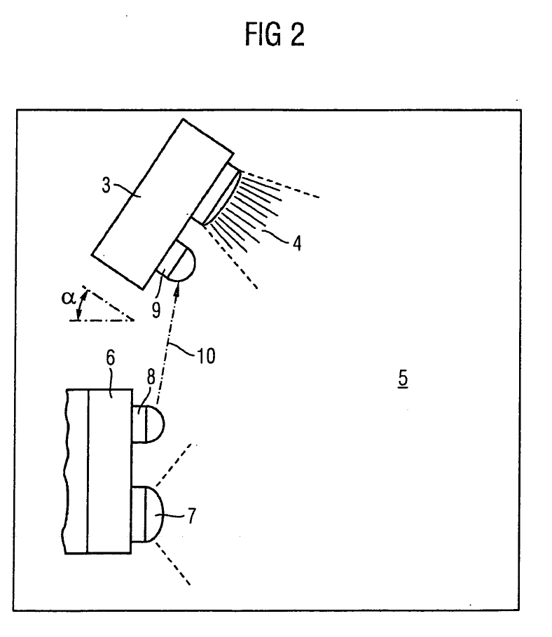

FIG. 2 an enlarged detailed extract of the device in accordance with the invention shown in FIG. 1.

FIG. 1 shows a device in accordance with the invention for capturing an object or a person 2, in particular in the interior of a motor vehicle 1. The device includes at least one image capture unit 6, which is arranged for example between the driver's seat 12 and the passenger's seat 13 in the roof structure of the motor vehicle 1. The image capture unit 6 has a working link to an illumination unit 3 which is, in accordance with the invention, arranged to be spatially separated from the image capture unit 6 in the motor vehicle 1, for example in the roof structure adjacent to the A-post, or in the latter, or in some other suitable place such as on the rear-view mirror, beside the windscreen or some such location (not shown). To improve the casting of shadows, the illumination unit 3 is directed at the person or object 2, as applicable, and relative to the image capture unit 6 is arranged at an angle of α, which when the counter-lighting effect is being used can preferably be 135° to 180°, and which in FIG. 1 has, for example, been chosen as 140°. Insofar as it is useful, further illumination units (not shown) can also be provided. It is preferable if the power supply for the illumination unit(s) 3 is independent of that for the image capture unit 6.

For the purpose of synchronizing or controlling, as applicable, the units 3 and 6 there is a fiber optic cable 11, for example, arranged between the image capture unit 6 and the illumination unit 3 (shown on the left-hand side of FIG. 1). An alternative to this, and particularly preferred, is cordless synchronization between the units 3 and 6 effected (as shown on the right-hand side of FIG. 1) with the help of suitable facilities 8 and 9 for transmitting control light pulses 10.

The image capture unit 6 includes at least one image sensor 7 (shown on the right-hand side of FIG. 1). Preferably, however, image capture units 6 are provided with two image sensors 7 (shown on the left-hand side of FIG. 1). Image capture units 6 of this type are also called stereo cameras. The optical axes of the image sensors 7 of a stereo camera 6 are a definable distance apart and it is possible in an advantageous way to record a stereo image or a 3-D image, as applicable, of movable objects 2, for example, and to communicate them to a microcontroller (not shown) for further processing. With the help of algorithms, it is then possible to determine the distances from the objects or persons 2 to the image sensors 7.

FIG. 2 is based on FIG. 1, and shows an enlarged detail view of the device in accordance with the invention. For the purpose of improving the casting of shadows, the illumination unit 3 is aligned towards the person or object 2, as applicable, and relative to the image capture unit 6 it is in turn arranged at an angle of α, which, as an alternative or addition to FIG. 1, can preferably be 0° to 45°, and in FIG. 2 has been chosen by way of example as 40°. Preferably, the illumination unit 3 will alone be capable of emitting light pulses 4 for the purpose of illuminating an image field 5 which is to be captured. However, it is noted that combinations of the arrangement in accordance with the invention of image capture units 6 and illumination units 3, even with familiar image capture device, are not excluded. In particular—depending on the vehicle type or special application—further illumination units (not shown) may be useful in or on the motor vehicle 1, as appropriate, and/or in or adjacent to the image capture unit 6. It should be emphasized in addition that the use of the present invention for vehicle-related so-called external applications can also be appropriate.

It can also be clearly seen in FIG. 2 how, in accordance with the invention, the image capture unit 6 has an optical transmitter 8 which emits control light pulses 10 for the purpose of synchronizing or controlling, as applicable, the units 3 and 6. Correspondingly, the illumination unit 3 has an optical receiver 9, which receives the control light pulses 10. Cordless transmission of the control light pulses 10 is effected by means of an optical transmitter 8 or optical receiver 9, preferably using control light pulses 10 with a wavelength lying in the near infra-red range (IR)(>800 nm) which, for the purpose of avoiding mistriggering or to protect against external sources of infra-red like that of the illumination unit 3, or from locking and unlocking systems or the like, are preferably transmitted in modulated and/or encoded form. If there should be any propagation time delay between the image recording and illumination which needs to be compensated, this can be effected by earlier emission of the control light pulses, for example.

With the present invention, it is possible to deal with restricted space conditions in or on a motor vehicle 1 more simply and in an advantageous way. In addition, the present invention permits improved edge detection by the illumination unit 3 casting shadows on the structures and objects 2 inside or outside a motor vehicle 1. Finally, it permits simpler adaptation to different “carlines” or vehicle types. The present invention is thus suitable not only and particularly for occupant protection systems but for all motor vehicle related video systems using active IR illumination.

1-14. (canceled)

15. A device for detecting an object or a person, comprising:
at least one illumination unit configured to emit light pulses for illuminating an image field to be captured;
an image capture unit including at least one image sensor configured to receive reflected light pulses from an object or a person in the image field, and to capture image data of the object or the person;
said at least one illumination unit disposed spatially separate from said image capture unit;
one of said separately disposed illumination unit and said image capture unit:
including an optical transmitter configured to emit control light pulses for synchronizing or controlling said units; and
the other one of said separately disposed illumination unit and said image capture unit:
including an optical receiver for receiving the control light pulses.

16. The device according to claim 15, which further comprises a fiber optic cable for transmitting the control light pulses connected between said optical transmitter and said optical receiver.

17. The device according to claim 15, which comprises transmission facilities at said optical transmitter and at said optical receiver, for cordless transmission of the control light pulses.

18. The device according to claim 15, wherein said optical transmitter is a component of said image capture unit.

19. The device according to claim 15, wherein the control light pulses are transmitted in modulated and/or encoded form.

20. The device according to claim 15, wherein the control light pulses have a wavelength in a-near infra-red range.

21. The device according to claim 15, wherein said illumination unit is aligned towards the object or the person and, relative to the image capture unit, said illumination unit is oriented at a given angle α.

22. The device according to claim 21, wherein said given angle α lies in at least one range selected from the range between 0° and 45° and the range between 135° and 180°.

23. The device according to claim 15, wherein said illumination unit has a power supply independent of a power supply of said image capture unit.

24. The device according to claim 15, configured for use in an interior of a motor vehicle, with said illumination unit disposed in or on the motor vehicle.

25. A method of detecting an object or a person, which comprises:
operating the device according to claim 15 for detecting the object or the person.

26. A method of detecting an object or a person, which comprises:
providing:
at least one illumination unit configured to emit light pulses for illuminating an image field to be captured;
an image capture unit, disposed spatially separate from the illumination unit, the image capture unit including at least one image sensor for receiving reflected light pulses from an object or a person in the image field and capturing image data related to the object or person;
emitting control light pulses from an optical transmitter, with one of the illumination unit and the image capture unit, for synchronizing or controlling the units; and
receiving the control light pulses through an optical receiver, with the other one of the illumination unit and the image capture unit.

27. The method according to claim 26, which comprises detecting an object or a person inside a motor vehicle.

28. The method according to claim 26, which comprises transmitting the control light pulses over a fiber optic cable between the optical transmitter and the optical receiver.

29. The method according to claim 26, which comprises cordlessly transmitting the control light pulses.

30. The method according to claim 26, which comprises transmitting the control light pulses in modulated or encoded form.

31. The method according to claim 26, which comprises setting a wavelength of the control light pulses in the near infrared range.

32. The method according to claim 26, which comprises compensating a time offset by transmitting the control light pulses at an earlier point in time.
